(19) United States
(12) Patent Application Publication
(10) Pub. No.: US 2014/0271254 A1
(43) Pub. Date: Sep. 18, 2014

(54) LABOR SAVING DEVICE FOR USE WITH "T" HANDLED AIR PUMPS

(71) Applicant: Phillip Lewis Johnson, Elizabethtown, NC (US)

(72) Inventor: Phillip Lewis Johnson, Elizabethtown, NC (US)

(21) Appl. No.: 14/207,991

(22) Filed: Mar. 13, 2014

Related U.S. Application Data
(60) Provisional application No. 61/791,412, filed on Mar. 15, 2013.

(51) Int. Cl. F04B 9/14; G05G 1/04

(52) U.S. Cl. CPC F04B 9/14; G05G 1/04
USPC 417/53; 74/523; 417/544

(57) ABSTRACT

A leverage device includes elongated body connected to a pivoting base, and a means for attaching the elongated body to the “T” handle of a pump used in filling air tanks. In use one securely connects the pivoting base to a stationary vertical surface, connects the attachment assembly to a pump, and repeatedly moves the elongated body in an up-and-down motion. This action moves the attached pump's “T” handle, thereby causing the pump's piston to move with decreased effort and increased speed over the conventional motion of pumping. In this manner a compressed air tank can be filled to approximately 3,000 psi using human power only.

### CROSS-REFERENCE TO RELATED APPLICATIONS

This application claims the benefit of U.S. Provisional Application 61/791,412, which was filed on Mar. 15, 2013.

### BACKGROUND OF THE INVENTION

The present invention relates to pumping assistance devices, and more specifically, to a mounted and pivoting pump leverage device used in connection with variety of commercially available hand pumps for compressing air.

There are a variety of shooting devices that use compressed air as their power source. These shooting devices include pre-charged pneumatic (PCP) devices such as air rifles and pistols; airsoft guns; and paintball guns. These shooting devices require an air tank, which is typically either built into the shooting device itself, or is external but screws onto the shooting device. It is necessary to refill these air tanks regularly when the shooting device is being used, as a given tank of air provides a limited number of shots. By way of example, one PCP air tank typically provides only about 30 shots, depending on the specific shooting device.

Pre-charged pneumatic shooting devices are desirable insofar as they are multi-shot, accurate, and have little recoil, while airsoft guns and paintball guns are desirable because they are entertaining yet safer than standard firearms. However, the compressed air requirements of these shooting devices can be problematic. One can charge their shooting device air tank with compressed air, for example from a SCUBA tank, but this can be expensive, and SCUBA tanks are cumbersome to transport. Alternatively, one can manually pump their shooting device air tank with a hand pump. An example of a commercially available hand pump is the Benjamin High Pressure PCP Pump which fits Crosman and Benjamin PCP shooting devices.

Hand pumps for use with pre-charged pneumatic and other shooting devices are typically structurally similar to bicycle floor pumps. These devices typically function via a hand-operated piston, and require an up and down pumping motion that is carried out via a T-shaped handle, with the user's hands positioned on the horizontal top section of the T. During the up-stroke, this piston draws air through a one-way valve into the pump from the outside. During the down-stroke, the piston then displaces the air from the pump into the desired device, for example bicycle tire or air tank.

While hand pumps are more portable and economical than SCUBA tanks, they pose other challenges. Their biggest drawback is that most people don't have the physical strength and endurance necessary to achieve the desired air tank compression using a hand pump. More specifically, most grown men can pump to about 2,000 psi, but find it very difficult or impossible to reach 3,000 psi, the standard desired compression for a PCP tank. As a result, those using hand pumps can't fill their air tank to capacity, and must refill more frequently.

As can be seen, there is a need for a device that can be used with commercially available hand pumps. It is desirable that this device is particularly well suited for hand pumps which are used to fill air tanks for pre-charged pneumatic shooting devices such as rifles and pistols, and for airsoft and paintball guns. It is desirable that this device reduces the time and labor required to use a hand pump to achieve a desired compression. It is also desirable that this device allows a user to achieve a higher compression in their air tank than they could have achieved without the device when using human power alone. It is desirable that this device is easy to use, store, and transport.

### BRIEF DESCRIPTION OF THE DRAWINGS

FIG. 1 is a perspective view of a leverage device mounted to a vertical stationary surface and attached to a pump, in use in the downward pump position;

FIG. 2 is a perspective view of a leverage device mounted to a vertical stationary surface and attached to a pump, in use in the upward pump position;

FIG. 3 is a close-up view of an attachment assembly attached to the body of a leverage device;

FIG. 4 is a perspective view of an attachment assembly in use, showing a pump handle attached;

FIG. 5 is a perspective view of a body attached to a housing;

FIG. 6 is another view of a body attached to a housing;

FIG. 7 is a close up view of a mounting assembly, showing the housing attached to the mounting plate, and the corresponding cross-sectional view taken along A-A; and

FIG. 8 is a side view of a leverage device mounted on a wall, depicting an exploded view of the retaining assembly.

### SUMMARY OF THE INVENTION

The leverage device of the present invention is essentially an elongated body connected to a pivoting mounting assembly. The elongated body preferably terminates in a comfortable grip, and the pivoting mounting assembly preferably securely connects to a stationary vertical surface such as a wall, fence or tree. Between the grip and the pivoting base is a means for attaching the elongated body to a pump, preferably a T-shaped handle of a pump used in filling air tanks. In use one securely connects the pivoting mounting assembly to a stationary surface, connects the attachment assembly to a pump, and repeatedly moves the grip in an up-and-down motion. This action moves the attached pump's T-shaped handle, thereby causing the pump's piston to move with decreased effort and increased speed over the conventional motion of pumping.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The following structure numbers shall apply to the following structures among the various FIGS.:
10—Leverage device;
15—Body;
20—Grip;
30—Attachment assembly;
32—U-bolt;
34—Bolt sheath;
36—Bolt threads;
38—Jig knobs;
39—Jig aperture;
40—Body sheath;
42—Mid-body apertures;
44—Proximal body apertures;
50—Mounting assembly;
52—Mounting plate;
53—Plate aperture;
55—Plate indentation;
57—Housing;
58—Wall;
59—Wall aperture;
60—Base;
61—Base aperture;
62—Attachment means;
63—Pivot axis;
65—Busching;
67—Wall gap;
70—Retaining assembly;
72—Clip;
73—Clip aperture;
74—Retaining plate;
75—Plate aperture;
80—Support structure;
100—Pump handle; and
105—Pump.

Referring to FIGS. 1 and 2, leverage device 10 generally includes elongated body 15 terminating at a proximal end in mounting assembly 50, and at a distal end with grip 20. Grip 20 is desirably fairly resilient foam rubber, or the like, which allows a user to comfortably squeeze and exert pressure on the device.

Located on body 15 between mounting assembly 50 and grip 20 is attachment assembly 30. As shown in FIG. 3, attachment assembly 30 generally includes U-bolt 32 partially covered with bolt sheath 34 and including unsheathed bolt threads 36. As envisioned by looking at FIG. 3, U-bolt 32 engages with body 15 at mid-body apertures 42, with bolt threads 36 traversing jig apertures 39 (see FIG. 4) of jig knobs 38.

As shown best in FIG. 4, attachment assembly 30 is configured to releasably engage with pump handle 100 of a commercially available pump. To accommodate various sizes of pump handles 100, the handle receiving region (unnumbered) formed within the arch of U-bolt 32 can be enlarged and minimized, and subsequently “locked in” by using jig knobs 38 in different positions on bolt threads 36. It is desirable that body sheath 40 is positioned on body 15 between prongs of U-bolt 32, to serve as a T handle cushion and friction pad in use.

Leverage device 10 is secured to a surface by mounting assembly 50. As would be understood by those in the art, mounting on a wall could be beneficial for filling air tank, for example, at home, but it is also possible to use leverage device 10 “in the field” by temporarily attaching to a surface such as a tree or fence. Referring to FIG. 7, mounting assembly 50 generally includes mounting plate 52 which defines plate aperture 53, and attached housing 57 (FIGS. 5 and 6). Housing 57 is attached to mounting plate 52 by attachment means 62 which traverse base apertures 61, as shown in FIGS. 5 and 7, respectively. FIG. 7 depicts various structures of mounting assembly 50, but it should be understood that body 15 is removed to show underlying structures.

Housing 57 generally includes base 60 which is substantially parallel to, and adjoining planar surface of mounting plate 52. Housing 57 also includes wall 58, which is connected to and substantially perpendicular to base 60. It is preferred that wall 58 forms a semi-circle, and defines wall gap 67 (see FIG. 6).

Referring to FIGS. 5 and 6, housing 57 engages pivot axis 63, at wall apertures 59. In use, proximal body apertures 44 of body 15 engage with pivot axis 63, thereby securing body 15 to housing 57. In this manner, body 15 can pivot relative to mounting assembly 50. As shown in FIG. 7, mounting plate 52 preferably includes plate indentation 55 to permit free pivoting of body 15. It is also preferred that pivot axis 63 includes a plurality of bushings 65 to facilitate free movement (FIGS. 5 and 6). It is also preferable that body 15 terminates in ¾″ plug for aesthetic and safety reasons.

As shown in FIG. 8, leverage device 10 is preferably attached to a surface, here wall 80, with mounting assembly 50 nearest the ground. Although not visible, pivot axis 63 is preferably longitudinally oriented parallel to ground, thereby permitting body 15 to pivot upwardly and downwardly. Likewise, wall gap 67 should be oriented upwardly, allowing free upward movement of body 15.

In use, one could attach air tank to standard air pump having pump handle 100. Next, attachment assembly 30 of surface-mounted leverage device could be engaged and secured with pump handle 100 using U-bolt 32 and jig knobs 38 as discussed herein. A user could then grasp grip 20 and exert upward and downward motion, thereby moving body 15 up and down, attachment assembly 30 up and down, and causing attached pump handle 100 to effectuate pumping of air into tank. This action could continue until desired air tank capacity is reached.

While approximately 3,000 psi is considered the general limit for air tanks, the present invention is capable of compression to approximately 3,600 psi without exerting unreasonable force. In other words an adult could pump to at least 3,600 with relative ease. The actual physical limit of the present invention is believed to considerably higher than 3,600 psi, but was not determined by the inventor due to damage which would likely occur to seals and other structures of the air tank.

When not in use, it is desirable to pivot body 15 upwardly until it is substantially perpendicular with mounting surface, and engage at retaining assembly 70, as shown in FIG. 8. As best shown in exploded view in FIG. 8, retaining assembly preferably includes retaining plate 74 that is engaged with mounting surface such as wall 80, and clip 72 that releasably grasps body 15 for storage. Clip aperture 73 facilitates connection between clip 72 and retaining plate 74, and plate aperture 75 facilitates connection between retaining plate 74 and mounting surface. In this manner body 15 can be pivoted up and down relative the mounting assembly, similar to how a wall-mounted ironing board is lowered for use and raised for storage.

Specifications of certain structures and components of the present invention have been established in the process of developing and perfecting prototypes and working models. These specifications are set forth for purposes of describing an embodiment, and setting forth the best mode, but should not be construed as teaching the only possible embodiment. Rather, it should be understood that all specifications, unless otherwise stated or contrary to common sense, are +/−10%. It is preferred that body 15 measures approximately 4′ long, measured from grip 20 to mounting assembly 50. Body 15 is preferably constructed of 1″ wide iron tubing having walls of approximately ⅛″, therefore having an inner diameter of ¾″. It is desirable that U-bolt 32 is 4″ long, and has a 2″ wide clearance, except this clearance would be less when 5/16″ rubber tubing is employed as bolt sheath 34. It is desirable that U-bolt 32 prongs are 5/16″. It is preferred that body sheath 40 is constructed of tubing having a 1″ inner diameter and 1⅛″ outer diameter. It is desirable that jig knobs 38 are two female jig knobs having 5/16″ jig apertures 39. It is possible to employ a commercially available shower curtain rod holder, preferably constructed of a very resilient material, for housing 57, although it would be necessary to create wall apertures 59 in order to accommodate pivot axis 63. It is desirable that pivot axis 63 is constructed of a male to female barrel bolt with internal bushings that are positioned between wall 58 and body 15. It is desirable to use wood as mounting plate 52 and retaining plate 74.

It should be understood, of course, that the foregoing relates to exemplary embodiments of the invention and that modifications may be made without departing from the spirit and scope of the invention as set forth in the following claims. It should also be understood that ranges of values set forth inherently include those values, as well as all increments between.

What is claimed is:

1. A leverage device including:
A. An elongated body having a proximal end, a distal end, and mid-body portion there between;
B. A mounting assembly connected to said proximal end;
C. A grip engaged with said distal end; and
D. An attachment assembly connected to said mid-body portion.

2. The leverage device of claim 1 wherein said mounting assembly includes a mounting plate having at least one planar surface.

3. The leverage device of claim 1 wherein said mounting device includes a housing, said body pivotable with respect to said housing.

4. The leverage device of claim 3 wherein said housing includes a base and at least one wall.

5. The leverage device of claim 4 wherein said base is substantially perpendicular with respect to said wall.

6. The leverage device of claim 4 wherein said at least one wall defines a wall gap.

7. The leverage device of claim 1 wherein said attachment assembly includes a removable U-bolt.

8. The leverage device of claim 7 wherein said U-bolt traverses said body.

9. The leverage device of claim 8 wherein said U-bolt is secured to said body with jig knobs.

10. The leverage device of claim 7 wherein said U-bolt is partially enclosed in a bolt sheath.

11. A compressed air tank filling system including:
A. An air pump having a T-shaped handle; and
B. A leverage device releasably engaged with said T-shaped handle.

12. The compressed air tank filling system of claim 11 wherein said leverage device includes an elongated body having a distal end terminating in a grip.

13. The compressed air tank filling system of claim 12 wherein said elongated body includes a proximal end terminating in a mounting assembly, said elongated body pivotable with respect to said mounting assembly.

14. The compressed air tank filling system of claim 11 wherein said leverage device includes a U-bolt for releasably engaging with said T-shaped handle.

15. A method for filling an air tank with compressed air including the steps of:
A. Connecting an air tank to an air pump having a T-shaped handle;
B. Engaging said T-shaped handle with a leverage device having an elongated body; and
C. Pumping the distal end of said elongated body to effectuate corresponding movement of said T-shaped handle, said pumping performed manually by a human.

16. The method for filling an air tank with compressed air of claim 15 further including the step of securing a mounting assembly to a substantially vertical and stable support structure, said mounting assembly at the distal end of said elongated body.

17. The method for filling an air tank with compressed air of claim 15 further including the step of filling said air tank to a pressure exceeding 2,500 psi.
